(19) United States
(12) Patent Application Publication
(10) Pub. No.: US 2024/0340516 A1
(43) Pub. Date: Oct. 10, 2024

(54) FOCUS ADJUSTMENT METHOD

(71) Applicant: DENSO CORPORATION, Kariya-city (JP)

(72) Inventors: Ryohei OKAMOTO, Kariya-city (JP); Noboru KAWASAKI, Kariya-city (JP); Toshiki YASUE, Kariya-city (JP); Yasuki FURUTAKE, Kariya-city (JP); Hiroshi NAKAGAWA, Kariya-city (JP); Shunta SATO, Kariya-city (JP)

(21) Appl. No.: 18/749,400

(22) Filed: Jun. 20, 2024

Related U.S. Application Data
(63) Continuation of application No. PCT/JP2022/044527, filed on Dec. 2, 2022.

(30) Foreign Application Priority Data
Dec. 21, 2021 (JP) 2021-207022

(51) Int. Cl. H04N 23/54

(52) U.S. Cl. CPC H04N 23/54

(57) ABSTRACT

A focus adjustment method for a camera module equipped with an optical system, an image sensor, and a camera substrate to which said image sensor is mounted. The focus adjustment method includes a measurement step of measuring an installation position and an installation angle of the image sensor on the camera substrate, an adjustment step of adjusting a position and an angle of the camera substrate relative to the optical system, and an assembly step of assembling the camera substrate to the optical system after adjusting the position and angle of the camera substrate. The adjustment step includes adjusting the position and angle of the camera substrate based on the installation position and angle of the image sensor as measured so that a position and an angle of the image sensor relative to the optical system become a set position and a set angle predefined according to the optical system.

### CROSS-REFERENCE TO RELATED APPLICATION

This application is a continuation application of International Application No. PCT/JP2022/044527 filed Dec. 2, 2022 which designated the U.S. and claims priority to Japanese Patent Application No. 2021-207022 filed Dec. 21, 2021, the contents of each of which are incorporated herein by reference.

### BACKGROUND

### Technical Field

This disclosure relates to a focus adjustment method for a camera.

### Related Art

Conventionally, a plurality of camera modules are mounted to a vehicle, causing an increase in the demand for camera modules. The camera modules mainly use CCD or CMOS sensors. For such camera modules, there is a need for proper focus adjustment to adjust a mounting position of each sensor relative to the lens.

### BRIEF DESCRIPTION OF THE DRAWINGS

In the accompanying drawings:

FIG. 1 is an exploded, perspective view of a camera;

FIG. 2 is a schematic diagram of a camera module;

FIG. 3 is a block diagram of a focus adjustment system;

FIG. 4 is a schematic diagram illustrating transport of a camera substrate;

FIG. 5 is a schematic diagram illustrating adjustment of the camera substrate;

FIG. 6 is a schematic diagram illustrating how cruciform light sources are imaged by an image sensor;

FIG. 7A is a schematic diagram of the cruciform light sources in an imaging area;

FIG. 7B is a schematic diagram of the cruciform light sources in a scanning area;

FIG. 8 is an example of MTF curves;

FIG. 9 is a schematic diagram of a depth of focus;

FIG. 10 is an example of MTF curves in an in-focus assembly state;

FIG. 11 is a schematic diagram illustrating irradiation with laser light;

FIG. 12 is a flowchart of a focus adjustment process;

FIG. 13A-13D are schematic diagrams illustrating a process of thermal expansion and subsequent shrinkage during temporary curing;

FIG. 14 is a flowchart of a prediction process; and

FIG. 15 is an illustration of a separation distance.

### DESCRIPTION OF SPECIFIC EMBODIMENTS

In some cases, focus adjustment is performed visually and manually, but there are variations in accuracy and a lot of work time and effort is required. Thus, in recent years, focus adjustment is often performed automatically. According to known techniques, as disclosed in JP 2002-267923 A, JP 2009-3152 A, and JP 2008-171866 A, it is now possible to reduce a focus adjustment time, that is, a work time required for focus adjustment, without reducing the accuracy of focus adjustment.

However, there is still room for improvement in focus adjustment time.

In view of the foregoing, it is desired to have a focus adjustment method capable of reducing a focus adjustment time.

A first aspect of the present disclosure provides a focus adjustment method for a camera module equipped with an optical system, an image sensor, and a camera substrate to which said image sensor is mounted. The focus adjustment method includes a measurement step of measuring an installation position and an installation angle of the image sensor on the camera substrate, an adjustment step of adjusting a position and an angle of the camera substrate relative to the optical system, and an assembly step of assembling the camera substrate to the optical system after adjusting the position and angle of the camera substrate in the adjustment step. The adjustment step includes adjusting the position and angle of the camera substrate based on the installation position and installation angle of the image sensor as measured in the measurement step so that a position and an angle of the image sensor relative to the optical system become a set position and a set angle predefined according to the optical system.

According to the above configuration, since the installation position and installation angle of the image sensor on the camera substrate are measured in advance in the measurement step, the position and angle of the camera substrate relative to the optical system can be adjusted in the adjustment step so that the image sensor is at the set position and set angle predetermined according to the optical system. Therefore, it is possible to shorten the time required to adjust the image sensor to be in focus when the camera substrate is assembled to the optical system.

A second aspect of the present disclosure provides a focus adjustment method for a camera module equipped with an optical system, an image sensor, and a camera substrate to which the image sensor is mounted. The focus adjustment method includes an in-focus state identification step of causing the image sensor to image a chart image disposed at a predefined position through the optical system and analyzing imaging data to identify an assembly state of the image sensor that in focus, an adjustment step of adjusting a position and an angle of the camera substrate relative to the optical system so that the image sensor is in the assembly state identified in the in-focus state identification step, and an assembly step of assembling the camera substrate to the optical system. The in-focus state identification step includes acquiring a plurality of pieces of imaging data by causing the image sensor to image the chart image while continuously moving the camera substrate without stopping movement of the camera substrate, and then analyzing the plurality of pieces of imaging data.

When capturing chart images after stopping the image sensor, it is necessary to provide a waiting time to wait until vibrations caused by stopping the sensor subside, which increases the work time. However, as in the above configuration, when causing the image sensor to capture the chart images while continuously moving the image sensor, vibrations caused by stopping the image sensor are not generated, which allows imaging data to be acquired continuously without providing the waiting time, thereby shortening the work time required to identify the in-focus assembly state.

Hereinafter, a plurality of exemplary embodiments which embody the “focus adjustment method” of the present disclosure will be described in detail with reference to the accompanying drawings. In the present embodiment, the direction parallel to the optical axis is the Z-direction, the vertical direction (up-down direction) orthogonal to the Z-direction is the X-direction, and the horizontal direction (left-right direction) orthogonal to the Z-direction is the Y-direction.

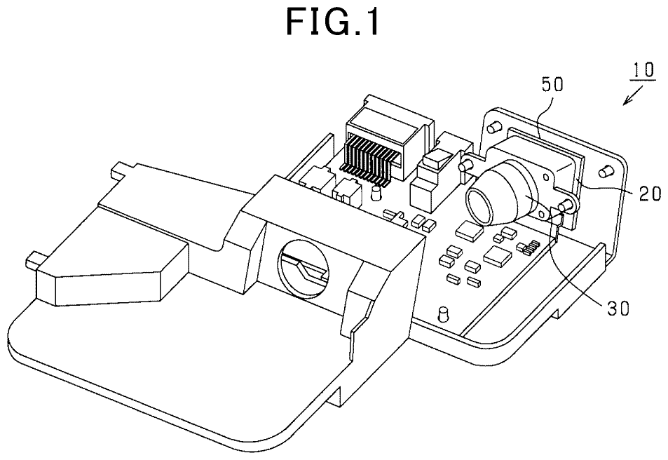

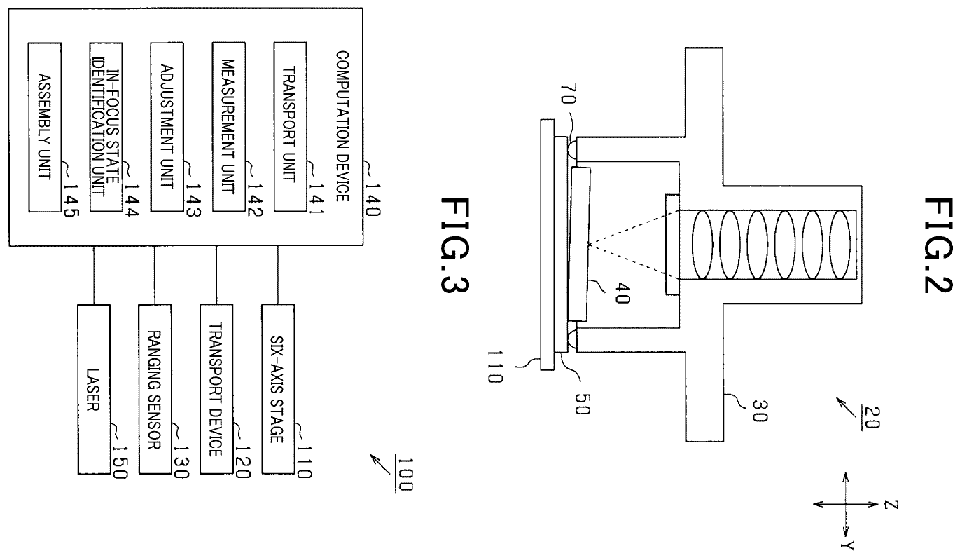

As illustrated in FIG. 1, the camera 10 is equipped with a CMOS camera module with lens (in the following, simply called a camera module 20). As illustrated in FIG. 2, the camera module 20 includes a lens module 30 as an optical system, an image sensor 40, and a camera substrate 50 to which the image sensor 40 is mounted. The image sensor 40 is an imaging device such as a CMOS. The lens module 30 is fixed to the camera substrate 50 to form the camera module 20. The lens module 30 is fixed to the camera substrate 50 using an adhesive (such as a thermoset adhesive) 70.

Next, the focus adjustment system 100 will now be described. As illustrated in FIG. 3, the focus adjustment system 100 includes a six-axis stage 110 as a position adjustment device, a transport device 120, a ranging sensor 130, a computation device 140, and a laser 150 capable of emitting laser light.

The six-axis stage 110 is equipped with a mechanism to change the position and tilt of the camera substrate 50 to which the image sensor 40 is mounted. In the present embodiment, the six-axis stage 110 is configured to adjust positions in the X-, Y-, and Z-directions, and roll, yaw, and pitch angles (six axes in total).

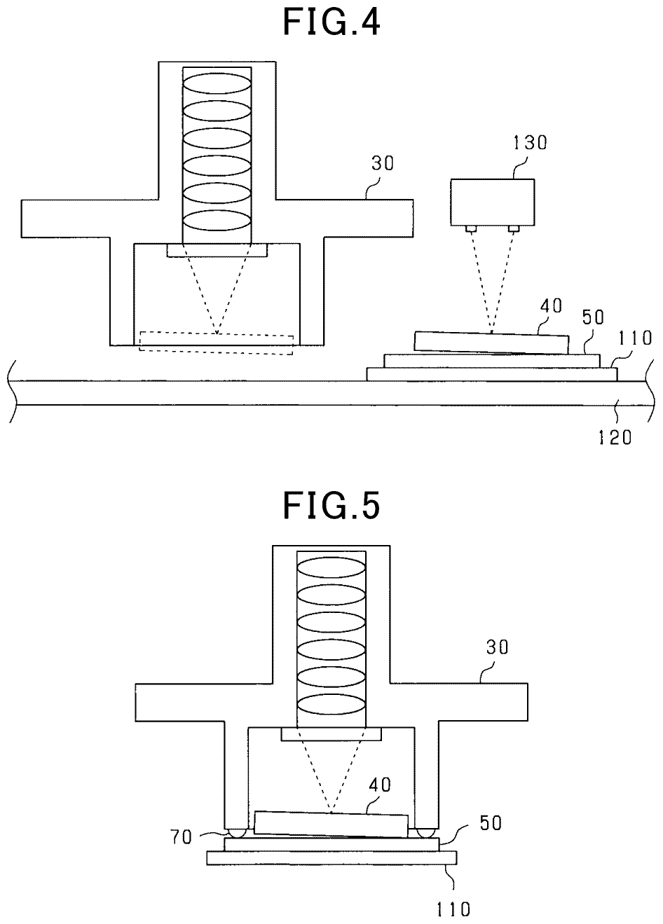

The transport device 120 is used to transport the six-axis stage 110 to which the camera substrate 50 is mounted. As illustrated in FIG. 4, the transport device 120 transports the entire six-axis stage 110 until the image sensor 40 of the camera substrate 50 reaches a facing position where the image sensor 40 faces the lens of the lens module 30.

The ranging sensor 130 is configured to measure the installation distance and installation angle of the image sensor 40 on the camera substrate 50 during transport by the transport device 120. That is, the image sensor 40 is fixed to the camera substrate 50 by bonding, soldering or the like, but there may be some errors due to assembly accuracy. Therefore, a state in which the image sensor 40 is fixed to the camera board 50, which is represented by the installation distance and installation angle, is measured. The ranging sensor 130 measures the installation distance and installation angle of the image sensor 40 relative to a predetermined reference point. Specifically, the ranging sensor 130 measures the positions in the X-, Y-, and Z-directions, as well as the roll angle, yaw angle, and pitch angle. The reference point is, for example, a predefined point on the camera substrate 50.

The computation device 140 is equipped with a CPU, a RAM, a ROM, and other components, and implements various functions by executing one or more programs stored in the ROM. The computation device 140 also includes various input/output devices to receive various instructions and output results. As illustrated in FIG. 3, the computation device 140 is connected to the six-axis stage 110, the transport device 120, the ranging sensor 130, and the laser 150, so as to receive from and output to these devices various signals. The various signals include, for example, instruction signals to provide notifications of instructions, measurement signals to provide notifications of measurements, and the like.

The computation device 140 includes, as various functional blocks, a transport unit 141, a measurement unit 142, an adjustment unit 143, an in-focus state identification unit 144, and an assembly unit 145. It is not necessary to incorporate all of these functions in the single computation device 140, but rather, these functions may be distributed among multiple computation devices.

The computation device 140, as the transport unit 141, controls the transport device 120 so that the camera substrate 50 and the six-axis stage 110 are transported until the image sensor 40 reaches the facing position at which the image sensor 40 faces the lens of the lens module 30.

The computation device 140, as the measurement unit 142, controls the ranging sensor 130 to cause it to measure the installation position and installation angle of the image sensor 40 on the camera substrate 50 during transport.

The computation device 140, as the adjustment unit 143, controls the 6-axis stage 110 so as to adjust the position and angle of the camera substrate 50 relative to the lens module 30. Specifically, as illustrated in FIG. 5, after the six-axis stage 110 is transported by the transport device 120, the adjustment unit 143, taking into consideration the installation position and installation angle of the image sensor 40 measured by the measurement unit 142, adjusts the position and angle of the image sensor 40 relative to the lens module 30 to become an optimum position and an optimum angle. The optimum position and optimum angle correspond to the set position and set angle predetermined by the lens module 30, respectively.

The optimum position and optimum angle are predetermined by the lens module 30 so that when the image sensor 40 is positioned at the optimum position and optimum angle, the image sensor 40 is almost in focus. The optimum position and optimum angle are measured in advance by a manufacturer of the lens module 30, as indicated by the dashed lines in FIG. 4. The adjustment unit 143 adjusts the position and angle of the image sensor 40 relative to the lens module 30 to become the optimum position and optimum angle. As described above, there may be deviations in position and angle of the image sensor 40 mounted on the camera substrate 50. Thus, the position and angle of the camera board 50 is adjusted taking into account such errors.

Typically, the position and angle of each of selected ones of finished lens modules 30 are measured, and the average of the measured positions and the average of the measured angles are used as the optimum position and optimum angle. Alternatively, the optimum position and optimum angle may be calculated from the blueprint or the like. Thus, depending on individual lens modules 30, there may be some manufacturing errors. In other words, even if the position and angle of the image sensor 40 are adjusted to the optimum position and optimum angle, the image sensor 40 may be out of focus.

Therefore, the computation device 140, as the in-focus state identification unit 144, causes chart images disposed at predefined positions to be captured by the image sensor 40 via the lens module 30, and analyzes the imaging data to identify the assembly state of the image sensor 40 in focus, which will now be described in detail in the following.

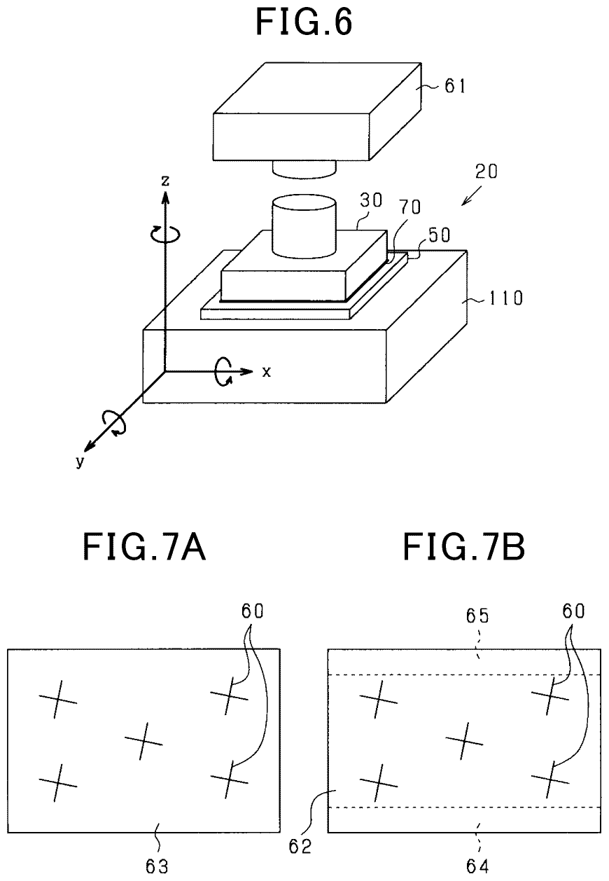

In the present embodiment, as illustrated in FIG. 6, the light source 61 is covered with a sheet (e.g., black paper) having cross slits formed, and then light is emitted from the light source 61 to the camera module 20, thereby generating cruciform light sources 60 as chart images, as illustrated in FIG. 7. That is, the cruciform light sources (cross slit light) 60 generated by light passing through the cross slits of the sheet provide chart images. These cruciform light sources 60 are generated at multiple positions, each disposed at a predetermined position. For example, as illustrated in FIGS. 7A and 7B, the cruciform light sources 60 are disposed at five positions, that is, at the middle position, the upper right position, the lower right position, the upper left position, and the lower left position in the imaging area 63 that can be imaged by the camera module 20.

The computation device 140, as the in-focus state identification unit 144, causes the image sensor 40 to image each cruciform light source 60 through the lens module 30, and analyzes imaging data to calculate Modulation Transfer Function (MTF) curves for each cruciform light source 60. The MTF curves provide one of indicators for evaluating lens performance, expressing how faithfully the contrast of the subject (chart image) can be reproduced as a spatial frequency characteristic in order to know imaging performance of the lens.

Specifically, the computation device 140 images each of the cruciform light sources 60 at a plurality of positions in the Z-axis direction (Z-axis positions), analyzes the imaging data of each cruciform light source 60, and calculates MTF values (%) corresponding to the contrast. The vertical (X-direction) slit and the horizontal (Y-direction) slit in each cruciform light source 60 are distinguished to calculate the MTF values. Therefore, in the present embodiment, a total of 10 MTF values are calculated at each Z-axis position.

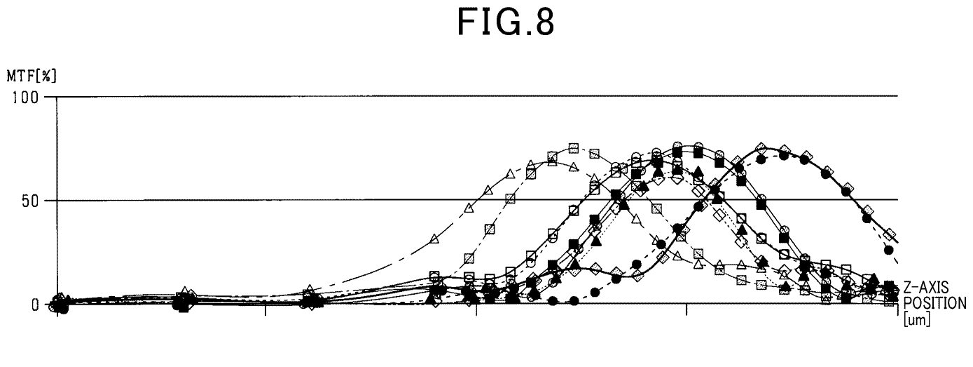

After moving and scanning the camera substrate 50 within the predefined scanning range, the computation device 140 plots the calculated MTF values in the coordinates where the vertical axis represents the MTF value and the horizontal axis represents the Z-axis position, and connects the MTF values to calculate the MTF curves. In the present embodiment, a total of 10 MTF values are calculated at each of the Z-axis positions, so a total of 10 MTF curves are calculated as illustrated in FIG. 8.

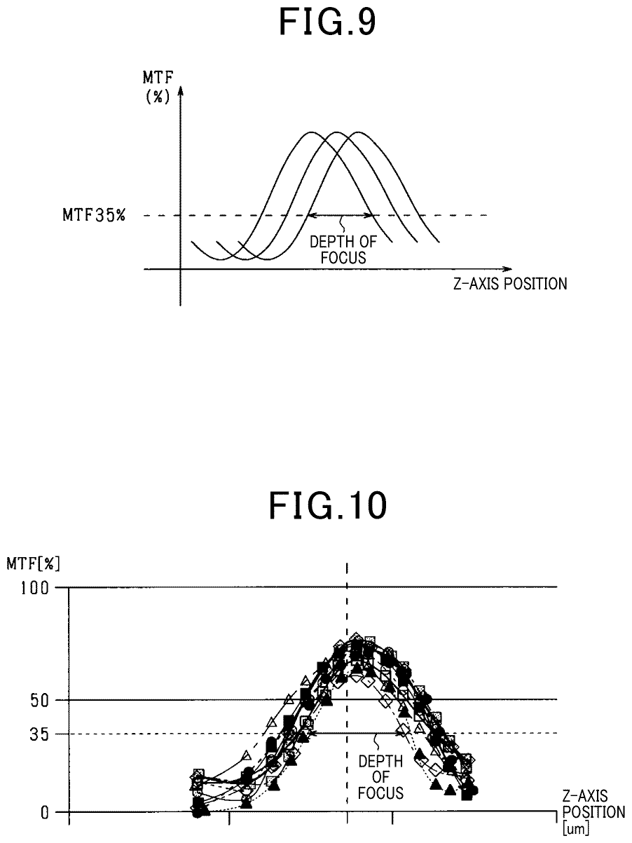

After acquiring the 10 MTF curves, the computation device 140, as illustrated in FIG. 9, calculates correction values to correct the position and tilt of the image sensor 40 so that the depth of focus is maximized at a MTF value predefined in the product standard (e.g., 35%). Specifically, the peaks of the MTF curves are brought closer to each other so that the distance corresponding to the depth of focus shown in FIG. 9 is maximized. Then, as illustrated in FIG. 10, when the depth of focus is maximized, the amount of movement of each MTF curve in the Z-axis direction is calculated, and from each amount of movement, a correction value for each of the position in the X-axis direction, the position in the Y-axis direction, and the position in the X-axis direction, and a correction value for each of the roll angle, the yaw angle, and the pitch angle are calculated. The computation device 140 then identifies the assembly state of the image sensor 40 in focus based on the calculated position and angle correction values. The computation device 140 then controls the six-axis stage 110 so that the image sensor 40 is in the identified assembly state by adjusting the position and angle of the camera substrate 50 based on each correction value, as illustrated in FIG. 6.

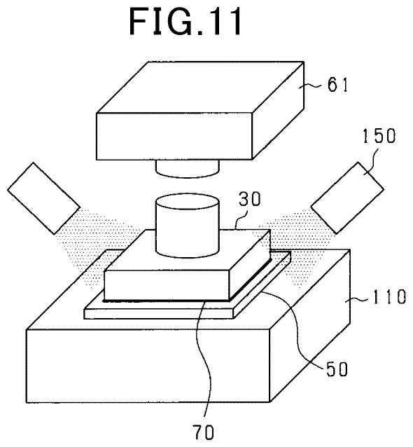

The computation device 140, as the assembly unit 145, controls the laser 150 to irradiate an adhesive 70 applied to the camera substrate 50 with laser light, as illustrated in FIG. 11, after the image sensor 40 has been placed in the identified assembly state. That is, while the lens module 30 and the camera substrate 50 are adhered together via the adhesive 70, the adhesive 70 is irradiated with laser light to heat it. This temporarily cures the adhesive 70 and assembles the camera substrate 50 to the lens module 30.

By the way, in order to calculate the MTF curves as described above, it is necessary to image the cruciform light sources 60 at a plurality of different Z-axis positions, and it is necessary to move the camera substrate 50 in the Z-axis direction. However, when the camera substrate 50 is moved and then brought to a stop, vibration occurs when the camera substrate 50 is stopped. Since capturing the chart images while vibrations are occurring may cause errors, it is necessary to wait for the vibrations to subside each time the camera substrate 50 is brought to a stop, which leads to an increased work time. Therefore, in the present embodiment, the following is devised to reduce the work time.

As a first device, the computation device 140 controls the six-axis stage 110 to move in the Z-axis direction within a predefined scanning range set with respect to the optimum position and optimum angle. The scanning range is, for example, a predefined range in the Z-axis direction centered at the optimum position.

As a second device, the computation device 140 causes the image sensor 40 to capture images while moving the camera substrate 50 continuously without stopping it within the predefined scanning range, thereby acquires a plurality of pieces of imaging data, and analyzes the plurality of pieces of imaging data. In the present embodiment, the computation device 140 causes the image sensor 40 to capture images while moving the camera substrate 50 at a constant speed within the scanning range.

As a third device, the exposure time is reduced to the extent that the chart images can be identified. In the present embodiment, since the cruciform light sources 60 are used as the chart images, the exposure time may be reduced as compared to, for example, a case where chart images printed on paper are imaged. In the present embodiment, the exposure time is shorter than the common exposure times of 33.3 ms and 16.7 ms. Specifically, the exposure time is 0.7 ms.

As a fourth device, the scanning area 62 is set by limiting the imaging area 63 that can be imaged by the image sensor 40. Specifically, since the area in which the cruciform light sources 60 are present is predefined, the area in which the cruciform light sources 60 are not present is not imaged. For example, as illustrated in FIG. 7A, the upper end area 65 of the original imaging area 63 and the lower end area 64 of the original imaging area 63, where the cruciform light sources 60 are not present, are omitted and the scanning area 62 is used. In the present embodiment, when the vertical width of the original imaging area 63 is 1876 (pix) in the vertical direction (X-axis direction), the vertical width of the scanning area 62 is 1369 (pix). It is desirable to set the scanning area 62 to the extent that the cruciform light sources 60 may be sufficiently imaged after taking errors into consideration.

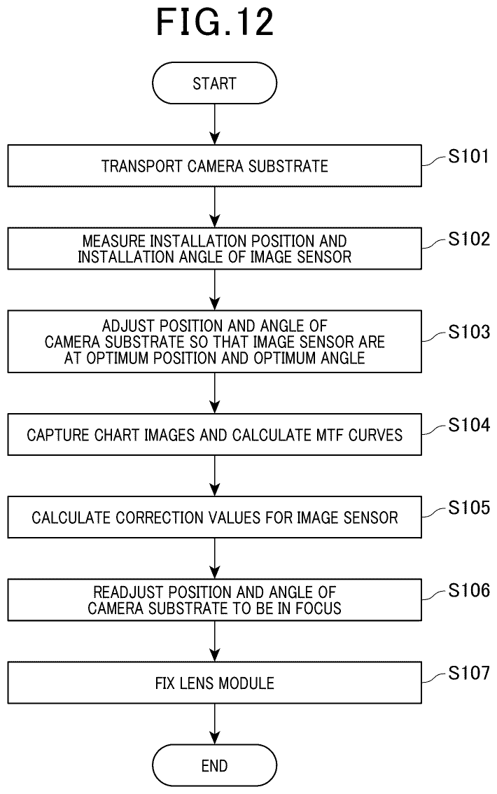

The process flow of the focus adjustment method of the present embodiment will now be described with reference to FIG. 12. The focus adjustment process described in the following is performed by the computation device 140.

First, the computation device 140, as the transport unit 141, initiates control of the transport device 120 so that the camera substrate 50 and the six-axis stage 110 are transported until the image sensor 40 reaches the facing position where the image sensor 40 faces the lens module 30 after the camera substrate 50 is placed on the transport device 120 (at step S101). This step S101 corresponds to a transport step. At step S101, the camera substrate 50 has already been applied with the adhesive 70 for bonding the lens module 30 to the camera substrate 50. However, if the adhesive 70 is applied at a later process (e.g., at step S107), the adhesive 70 does not have to be applied at this step.

The computation device 140, as the measurement unit 142, controls the ranging sensor 130 to measure the installation position and installation angle of the image sensor 40 on the camera substrate 50 during transport (step S102). This step S102 corresponds to a measurement step.

After the image sensor 40 arrives at the facing position, the computation device 140, as the adjustment unit 143, controls the six-axis stage 110 to adjust the position and angle of the camera substrate 50 (at step S103). At step S103, the computation device 140 adjusts the position and angle of the camera substrate 50 so that the position and angle of the image sensor 40 become the optimum position and optimum angle, taking into account the installation position and installation angle of the image sensor 40 measured at step S102.

Thereafter, the computation device 140, as in-focus state identification unit 144, causes the image sensor 40 to image each cruciform light source 60 as a chart image via the lens module 30, and analyzes the imaging data to calculate the MTF curves for each chart image (step S104). At step S104, the computation device 140 causes the image sensor 40 to capture images while moving the camera substrate 50 at a constant speed within the scanning range set with respect to the optimum position. The scanning area 62 is narrower than the imaging area 63 of the image sensor 40, and the exposure time is also reduced to shorten the frame rate. The timing for analyzing the imaging data and calculating the MTF curves for each chart image may be in parallel with acquisition of the imaging data, or may be preceded by acquisition of all the imaging data. In the present embodiment, the MTF curves of each of the chart images are calculated by analyzing the imaging data sequentially, in parallel with acquisition of the imaging data.

After acquiring the MTF curves, the computation device 140 calculates the correction values to correct the position and tilt of the image sensor 40 so that the depth of focus is maximized (at step S105). Steps S103 and S104 correspond to an in-focus state identification step.

Thereafter, the computation device 140 readjusts the position and angle of the camera substrate 50 based on the correction values calculated at step S105, and controls the six-axis stage 110 so that the image sensor 40 is in a specific assembly state in which the image sensor 40 is in focus (step S106). These steps S106 and S103 correspond to an adjustment step. In other words, the adjustment step may be performed once or multiple times as needed.

Then, the computation device 140 controls the laser 150 to cure (temporarily cure) the adhesive 70 applied between the lens module 30 and the camera substrate 50 by irradiating the adhesive 70 with laser light (step S107). That is, with the adhesive surface of the lens module 30 and the adhesive surface of the camera substrate 50 bonded together via the adhesive 70, the adhesive 70 is heated and cured by being irradiated with laser light. Step S107 corresponds to the assembly step. Thereafter, the camera substrate 50 and lens module 30 are stored in a thermostatic oven to allow the adhesive 70 to cure for main curing, and the lens module 30 is securely fixed to the camera substrate 50. This completes the camera module 20.

By the way, after adjusting the position and angle of the image sensor 40, the adhesive 70 is temporarily cured by irradiation with laser light at step S107. However, it has been found that the position is prone to shift after adjustment and before completion of temporary curing.

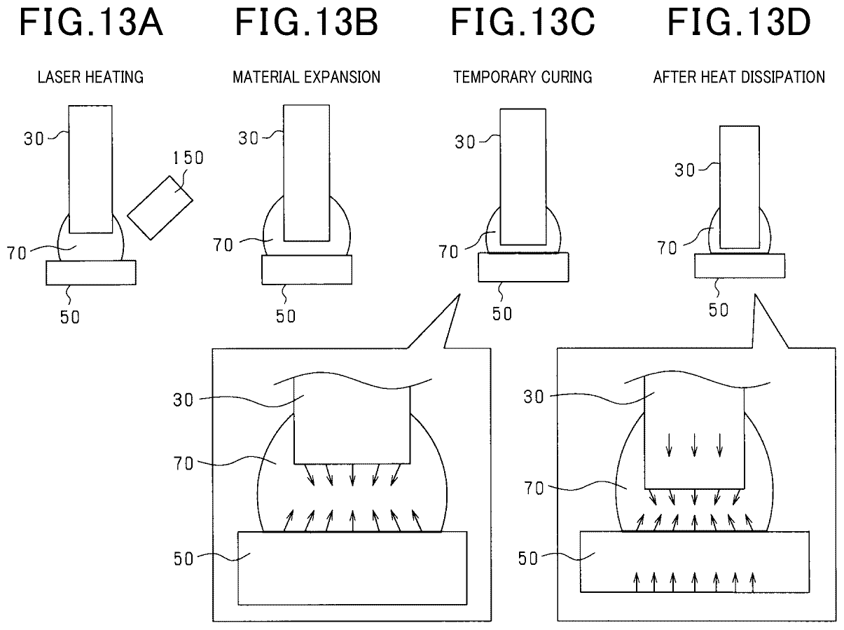

In detail, as illustrated in FIG. 13A, when irradiated with laser light, the adhesive 70, the lens module 30, and the camera substrate 50 are heated and temporarily expand thermally, as illustrated in FIG. 13B. Then, as illustrated in FIG. 13C, the lens module 30 and the camera substrate 50 are bonded to each other via their adhesive surfaces to which the adhesive 70 adheres as the adhesive 70 temporarily cures. At this time, as illustrated in the enlarged view of FIG. 13C, the adhesive 70 adheres to the adhesive surfaces of the lens module 30 and the camera substrate 50, and the adhesive 70 itself cures and shrinks. Thus, the lens module 30 and the camera substrate 50 are pulled closer to each other by each other's adhesive surfaces, as indicated by the arrows, as the adhesive 70 cures and shrinks.

Thereafter, when the heat is dissipated, each of the lens module 30, the camera substrate 50, and the adhesive 70 shrinks by its amount of expansion, as illustrated in the enlarged view of FIG. 13D. At this stage, the lens module 30 and the camera substrate 50 are pulled to each other by each other's adhesive surfaces, and the lens module 30 and camera substrate 50 are thus brought closer to each other by the amount of shrinkage. As a result, the lens module 30 and the camera substrate 50 are brought closer to each other after adjustment and before completion of temporary curing, causing a displacement. In addition thereto, it has also been found that the heat generated the laser light may cause the camera substrate 50 to warp, which also causes a displacement.

Therefore, such displacements are predicted, and in readjustment at step S106, the position and angle of the image sensor 40 are offset by the predicted displacements so that displacements are minimized at completion of temporary curing. Here, a distance in the Z-axis direction, by which the lens module 30 and the camera substrate 50 are brought closer to each other (a shrinkage distance, a shrinkage displacement) from readjustment at step S106 to completion of temporary curing, is simply called a shrinkage distance E100. First, the prediction of this shrinkage distance E100 will now be described.

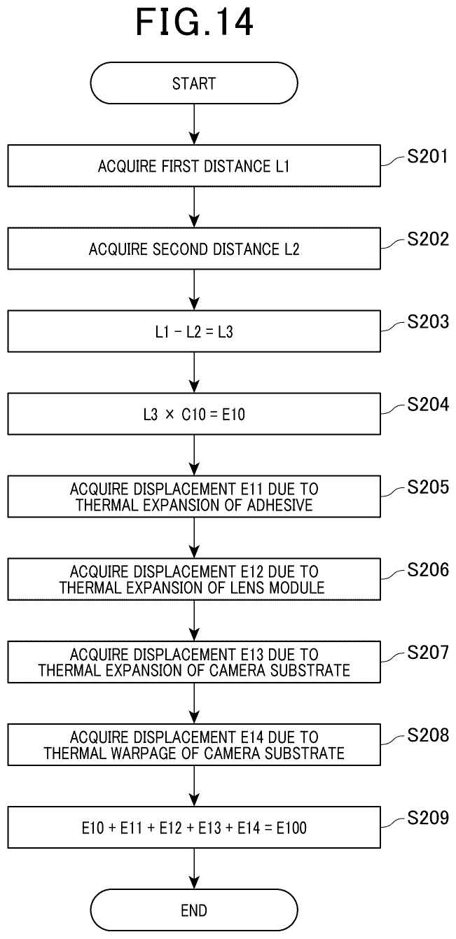

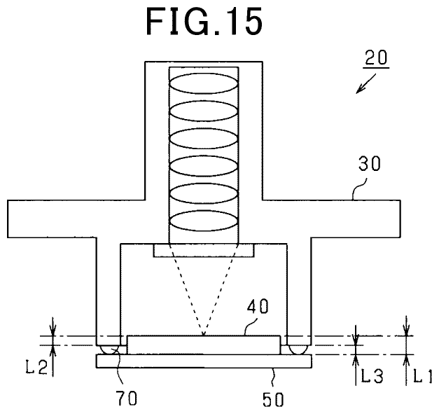

After completion of the process step S105 and before the process step S106 is performed, the computation device 140 performs a prediction process illustrated in FIG. 14. The computation device 140 first acquires a first distance L1 (see FIG. 15) from the surface of the image sensor 40 (on the lens module 30 side) to the surface of the camera substrate 50 (on the lens module 30 side) in the Z axis direction (at step S201). The computation device 140, at step S102, calculates and acquires the first distance L1 from the measured installation position and installation angle of the image sensor 40 on the camera substrate 50.

Since the rectangular-shaped image sensor 40 may be tilted and fixed to the camera substrate 50, there may be a difference in the first distance L1, depending on which position on the camera substrate 50 is used as a reference. However, considering that the difference is a minute difference, the first distance L1 is specified as the first distance L1 with respect to an arbitrary position on the camera substrate 50. In the present embodiment, the distance from the surface position of the image sensor 40 at the center of the image sensor 40 to the surface position of the camera substrate 50 is determined as the first distance L1.

Next, the computation device 140 acquires a second distance L2 (see FIG. 15) from the surface of the image sensor 40 to the adhesive surface of the lens module 30 in the Z-axis direction (step S202). The lens module 30 is bonded to the camera substrate 50 at four sides so as to surround the rectangular-shaped image sensor 40. Since the camera substrate 50 may be assembled at a tilt with respect to the lens module 30 for focus adjustment, there may be a difference in the second distance L2 depending on which position is used as a reference.

However, considering that the difference is a minute difference, the adhesive surface of the lens module 30 at any position along the four sides is used as a reference. In the present embodiment, the distance in the Z-axis direction between the adhesive surface at any of the four corners of the lens module 30 and the center of the image sensor 40 is determined as the second distance L2. Since the image sensor 40 is disposed at the optimum position and optimum angle, the second distance L2 can be determined from the optimum position and optimum angle of the image sensor 40 and the shape (designed dimensions) of the lens module 30. The second distance L2 may be actually measured by a sensor or the like.

The computation device 140 then calculates the difference between the first distance L1 and the second distance L2 and acquires this difference as a separation distance L3 (see FIG. 15) in the Z-axis direction from the lens module 30 to the camera substrate 50 (step S203).

The computation device 140 calculates a displacement E10 due to curing shrinkage of the adhesive 70 by multiplying this separation distance L3 by the coefficient C10 based on the physical properties of the adhesive 70 (at step S204). That is, experiments have shown that the distance by which the camera substrate 50 and the lens module 30 approach each other due to curing shrinkage of the adhesive 70 increases proportionally to the separation distance L3. Experiments have also shown that the proportionality coefficient (coefficient C10) depends on the physical properties of the adhesive 70. Therefore, in the present embodiment, the displacement E10 due to curing shrinkage of the adhesive 70 is calculated by multiplying the separation distance L3 by the coefficient C10 based on the physical properties of the adhesive 70. The coefficient C10 based on the physical properties of the adhesive 70 is determined by experiments or other means.

Next, the computation device 140 acquires a displacement E11 due to thermal expansion of the adhesive 70 and subsequent shrinkage of the adhesive 70 during heat dissipation (at step S105). In the following, the displacement E11 due to thermal expansion of the adhesive 70 and subsequent shrinkage of the adhesive 70 during heat dissipation may simply be referred to as the displacement E11 due to thermal expansion of the adhesive 70. Experiments have shown that the displacement E11 due to thermal expansion of the adhesive 70 increases in proportion to an increase in the temperature of the adhesive 70 caused by the laser light. Experiments have also shown that the proportionality coefficient (coefficient C11) varies depending on the shape of the adhesive 70 (thickness of the bonding point and amount of adhesive 70) and the physical properties of the adhesive 70. Therefore, the computation device 140 calculates and acquires the displacement E11 due to thermal expansion of the adhesive 70 by multiplying the increase in temperature of the adhesive 70 due to irradiation with laser light by a coefficient C11 based on the shape and physical properties of the adhesive 70.

Since an increase in temperature of the adhesive 70 due to irradiation with laser light is approximately constant, it can be determined by experiments or other means. Similarly, since the shape and physical properties of the adhesive 70 are almost the same, the coefficient C11 can be determined by experiments or other means. Therefore, the computation device 140 may pre-store it, read it from the storage unit at step S205, and calculate the displacement E11 due to thermal expansion of the adhesive 70. Similarly, the displacement E11 due to thermal expansion of the adhesive 70 is approximately constant and can be determined by experiments or other means. Therefore, the computation device 140 may pre-store the displacement E11 due to thermal expansion of the adhesive 70, and read it from the storage unit to acquire the displacement E11 at step S205. In the present embodiment, the displacement E11 is pre-stored.

The computation device 140 also acquires a displacement E12 due to thermal expansion of the lens module 30 and subsequent shrinkage of the lens module 30 during heat dissipation (at step S206). In the following, the displacement E12 due to thermal expansion of the lens module 30 and subsequent shrinkage of the lens module 30 during heat dissipation may simply be referred to as the displacement E12 due to thermal expansion of the lens module 30. Experiments have shown that the displacement E12 due to thermal expansion of the lens module 30 increases in proportion to an increase in the temperature of the lens module 30 caused by irradiation with laser light. Experiments have also shown that the proportionality coefficient (coefficient C12) depends on the shape (size and shape) of the lens module 30 and the material of the lens module 30. Therefore, the computation device 140 calculates and acquires the displacement E12 due to thermal expansion of the lens module 30 by multiplying the increase in temperature of the lens module 30 due to irradiation with laser light by the coefficient C12 based on the shape and physical properties of the lens module 30.

The increase in temperature of the lens module 30 due to irradiation with laser light is approximately constant, and can be determined by experiments or other means. Similarly, since the shape of the lens module 30 is almost the same, the coefficient C12 can be determined by experiments or other means. Therefore, the computation device 140 may pre-store it, read it from the storage unit at step S206, and calculate the displacement E12 due to thermal expansion of the lens module 30. Similarly, the displacement E12 due to thermal expansion of the lens module 30 is approximately constant and can be determined by experiments or other means. Therefore, the computation device 140 may pre-store the displacement E12 due to thermal expansion of the lens module 30, and read it from the storage unit to acquire it at step S206. In the present embodiment, the displacement E12 is pre-stored.

The computation device 140 acquires a displacement E13 due to thermal expansion of the camera substrate 50 and subsequent shrinkage of the camera substrate 50 during heat dissipation (at step S207). In the following, the displacement E13 due to thermal expansion of the camera substrate 50 and subsequent shrinkage of the camera substrate 50 during heat dissipation may be simply referred to as the displacement E13 due to thermal expansion of the camera substrate 50. Experiments have shown that the displacement E13 due to thermal expansion of the camera substrate 50 increases in proportion to the increase in the temperature of the camera substrate 50 due to irradiation with laser light. Experiments have also shown that the proportionality coefficient (coefficient C13) varies depending on the shape (size and shape) of the camera substrate 50 and the material of the camera substrate 50. Therefore, the computation device 140 calculates and acquires the displacement E13 due to thermal expansion of the camera substrate 50 by multiplying the increase in temperature of the camera substrate 50 due to irradiation with laser light by the coefficient C13 based on the shape and physical properties of the camera substrate 50.

Since an increase in temperature of the camera substrate 50 due to irradiation with laser light is approximately constant, it can be determined by experiments or other means. Similarly, since the shape or the like of the camera substrate 50 is almost the same, the coefficient C13 can be determined by experiments or other means. Therefore, the computation device 140 may pre-store it, read it from the storage unit at step S207, and calculate the displacement E13 due to thermal expansion of the camera substrate 50. Similarly, the displacement E13 due to thermal expansion of the camera substrate 50 is approximately constant and can be determined by experiments or other means. Therefore, the computation device 140 may pre-store the displacement E13 due to thermal expansion of the camera substrate 50, and read it from the storage unit to acquire the displacement E13 at step S207. In the present embodiment, the displacement E13 is pre-stored.

Then, the computation device 140 calculates a displacement E14 due to thermal warpage of the camera substrate 50 caused by an increase in temperature due to irradiation with laser light (at step S208). The displacement E14 due to thermal warpage of the camera substrate 50 caused by the increase in temperature due to irradiation with laser light is almost constant if the shape and material of the camera substrate 50 are the same, so it has been determined by experiments or other means and stored in the storage unit. At step S208, it is acquired by reading it from the storage unit.

The computation device 140 then predicts the shrinkage distance E100 by summing the various displacements E10 to E14 acquired at step S204 to step S208 (step S209). The prediction process is then ended. Steps S201-S209 correspond to a prediction step.

The computation device 140 adjusts the position of the camera substrate 50 after readjustment at step S106 so that the distance between the lens module 30 and the camera substrate 50 is increased in advance by the predicted shrinkage distance E100. That is, at step S106, the computation device 140 moves the camera substrate 50 away from the lens module 30 by the shrinkage distance E100 as compared to the specific assembly state that is in focus, thereby offsetting the predicted shrinkage distance E100. Alternatively, to reflect the shrinkage distance E100 in the correction values calculated at step S105, the correction may be offset by the shrinkage distance E100 in readjustment at step S106.

Effects of the focus adjustment method of the present embodiment will now be described.

At step S102, the computation device 140 measures the installation position and installation angle of the image sensor 40 on the camera substrate 50. Then, at step S103, the computation device 140, taking into account the measured installation position and installation angle, adjusts the position and angle of the camera substrate 50 so that the position and angle of the image sensor 40 with respect to the lens module 30 are the optimum position and optimum angle. That is, the state regarding how the image sensor 40 is installed on the camera board 50 is measured in advance, and the camera substrate 50 can be adjusted accurately so that the image sensor 40 is at a predefined optimum position and optimum angle, taking into account the measured installation position and installation angle. When assembling the camera substrate 50 to the lens module 30, this can reduce effort to adjust the image sensor 40 to be in focus. In addition, it is not necessary to bother to provide a time for measurement during transport, which can reduce the time for adjustment.

At step S104, when calculating the MTF curves, the computation device 140 captures images within the scanning range while changing the Z-axis position. The scanning range at step S104 is set with respect to the optimum position and optimum angle. This allows the scanning range to be narrowed. That is, when the image sensor 40 is disposed at an arbitrary position where the image sensor 40 faces the lens module 30, the positions of the MTF curves (positions of apexes or peaks) may deviate significantly because the image sensor 40 may not be in focus. Thus, in this case, when the image sensor 40 is disposed at an arbitrary position where the image sensor 40 faces the lens module 30, the scanning range needs to be widened assuming large deviations.

However, in the present embodiment, the position and angle of the image sensor 40 are adjusted to be at the optimum position and optimum angle. Therefore, the image sensor 40 is likely to be in focus, and the positional deviations of the MTF curves are likely to be small. Furthermore, in the present embodiment, the position and angle of the image sensor 40 on the camera substrate 50 are measured at step S102, and the position and angle of the camera substrate 50 are adjusted in consideration of these measurements. Therefore, the positional deviations of the MTF curves are likely to be even smaller. Thus, in this case, the scanning range is allowed to be narrower than the case where the image sensor 40 is disposed at an arbitrary position where the image sensor 40 faces the lens module 30.

Therefore, in the present embodiment, at step S103, the position of the focus point is searched while the image sensor 40 is in the in-focus assembly state to some extent, which allows the scanning range to be narrowed, thereby reducing the time required to identify the focus point.

When calculating the MTF curves at step S104, the computation device 140 causes the image sensor 40 to capture images while the camera substrate 50 is continuously moved by the six-axis stage 110 without stopping movement of the camera substrate 50. Thus, in this case, as compared to the case where movement of the camera substrate 50 is stopped and then the image sensor 40 capture images, it is no longer necessary to provide a waiting time to wait until the vibrations have subsided, and the time required for adjustment can be reduced.

At step S104, the frame rate can be shortened because the cruciform light sources 60 are used as chart images and the exposure time is shortened to the extent that the cruciform light sources 60 can be identified. That is, the speed at which the camera substrate 50 is moved can be made higher, and the time required for adjustment can be reduced.

At step S104, the top end area 65 and the bottom end area 64, which are areas where no chart images are present, are omitted from the imaging area 63, and the remaining area is used as the scanning area 62. This can shorten the frame rate. That is, the speed at which the camera substrate 50 is moved can be made higher, and the time required for adjustment can be reduced.

The shrinkage distance E100 that occurs after adjustment to completion of temporary curing is predicted, and the camera substrate 50 is moved away from the lens module 30 by the shrinkage distance E100 as compared to the specific assembly state in which the image sensor 40 is in focus, so that the shrinkage distance E100 is offset. This allows the image sensor 40 to be assembled so that the image sensor 40 is accurately in focus even if the lens module 30 and the camera substrate 50 approach each other before completion of temporary curing of the adhesive 70.

The shrinkage distance E100 includes the displacement E10 due to curing shrinkage of the adhesive 70. This allows the position of the camera substrate 50 to be offset more accurately. The displacement E10 due to curing shrinkage of the adhesive 70 is calculated by multiplying the separation distance L3 by the coefficient C10 based on the physical properties of the adhesive 70, which allows the displacement to be accurately predicted.

The displacement due to thermal expansion of the camera module 20 and subsequent shrinkage of the camera module 20 during heat dissipation is predicted and included in the shrinkage distance E100. The displacement due to thermal expansion of the camera module 20 and subsequent shrinkage of the camera module 20 during heat dissipation is predicted based on an increase in temperature during thermal expansion of the camera module 20 and a coefficient according to the shape and material of the camera module 20.

More specifically, the shrinkage distance E100 includes the displacement E11 due to thermal expansion of the adhesive 70. This allows the position of the camera substrate 50 to be offset more accurately. The displacement E11 due to thermal expansion of the adhesive 70 is calculated by multiplying an increase in the temperature of the adhesive 70 due to irradiation with laser light by the coefficient C11 based on the shape and physical properties of the adhesive 70, which allows the displacement to be accurately predicted.

The shrinkage distance E100 includes the displacement E12 due to thermal expansion of the lens module 30. This allows the position of the camera substrate 50 to be offset more accurately. The displacement E12 due to thermal expansion of the lens module 30 is calculated by multiplying an increase in the temperature of the lens module 30 due to irradiation with laser light by the coefficient C12 based on the shape and material of the lens module 30, which allows the displacement to be accurately predicted.

The shrinkage distance E100 includes the displacement E13 due to thermal expansion of the camera substrate 50. This allows the position of the camera substrate 50 to be offset more accurately. The displacement E13 due to thermal expansion of the camera substrate 50 is calculated by multiplying an increase in the temperature of the camera substrate 50 due to irradiation with laser light by the coefficient C13 based on the shape and material of the camera substrate 50, which allows the displacement to be predicted accurately.

The shrinkage distance E100 includes the displacement E14 due to thermal warpage of the camera substrate 50. This allows the position of the camera substrate 50 to be offset more accurately.

### Modifications

The acts performed as part of the focus adjustment method in the above embodiment may be modified. Modifications will now be described in the following.
(I) In the above embodiment, the imaging data of the chart images is analyzed to identify the assembly state of the image sensor 40 in focus, and the position of the camera substrate 50 is readjusted (at steps S104 to S106). Alternatively, if the required accuracy is satisfied, these processes may be omitted.
(II) In the above embodiment, the installation position and installation angle of the image sensor 40 on the camera substrate 50 are measured, and the position and angle of the image sensor 40 are adjusted to the optimum position and optimum angle of the camera substrate 50, taking these into account. Alternatively, if steps S104-S106 are performed, these processes may be omitted.
(III) At step S104 in the above embodiment, the scanning area 62 is set by omitting some portions of the imaging area 63. Alternatively, any portions of the scanning area 62 may be omitted.
(IV) At step S104 in the above embodiment, the scanning area 62 may be set by omitting the left and right end portions of the imaging area
(V) At step S104 in the above embodiment, the chart images do not need to be cruciform light sources 60. Alternatively, the chart images may be printed with any marks. The number, shapes or arrangement of the chart images may be changed arbitrarily.
(VI) At step S104 in the above embodiment, the exposure time may be changed arbitrarily.
(VII) In the prediction process of the above embodiment, when predicting the shrinkage distance E100, the displacement E10 due to temporary curing of the adhesive 70 may not be taken into account. This can eliminate the need to calculate the separation distance L3, thereby reducing the processing burden.
(VIII) In the prediction process of the above embodiment, the increase in temperature of the adhesive 70, the increase in temperature of the camera substrate 50, and the increase in temperature of the lens module 30 may be the same value. This allows the measurement process to be less laborious.
(IX) In the prediction process of the above embodiment, when predicting the shrinkage distance E100, the displacement E14 due to thermal warpage of the camera substrate 50 may not be taken into account.
(X) In the prediction process of the above embodiment, shrinkage distances E100 at a plurality of positions may be predicted, and the distance between the lens module 30 and the camera substrate 50 may be increased differently at the respective positions so that the shrinkage distances E100 are offset at the respective positions. For example, since the camera substrate 50 may be assembled tilted with respect to the lens module 30, the separation distance L3 between the lens module 30 and the camera substrate 50 at the left end may be different from the separation distance at the right end in the Y direction. The displacement E11 due to the curing shrinkage of the adhesive 70 differs depending on the separation distance L3. Thus, the shrinkage distances E100 at both the left and right ends in the Y-direction may be different from each other. Therefore, at any position (prediction position) at each end in the Y-direction, the separation distance L3 may be calculated and the shrinkage distance E100 may be predicted according to the calculated separation distance L3. The distance between the lens module 30 and the camera substrate 50 may be increased differently at the respective positions at each end in the Y-direction so that the shrinkage distances E100 are offset at the respective prediction positions at each end in the Y-direction.

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

What is claimed is:

1. A focus adjustment method for a camera module equipped with an optical system, an image sensor, and a camera substrate to which said image sensor is mounted, comprising:
a measurement step of measuring an installation position and an installation angle of the image sensor on the camera substrate by means of a ranging sensor;
an adjustment step of adjusting a position and an angle of the camera substrate relative to the optical system; and
an assembly step of assembling the camera substrate to the optical system after adjusting the position and angle of the camera substrate in the adjustment step, wherein
the adjustment step includes adjusting the position and angle of the camera substrate based on the installation position and installation angle of the image sensor as measured in the measurement step so that a position and an angle of the image sensor relative to the optical system become a set position and a set angle predefined according to the optical system.

2. The focus adjustment method according to claim 1, further comprising:
an in-focus state identification step of causing the image sensor to image a chart image disposed at a predefined position through the optical system and analyzing imaging data to identify an assembly state of the image sensor that in focus, wherein
the in-focus state identification step includes acquiring a plurality of pieces of imaging data by causing the image sensor to image the chart image within a predefined scanning range set with reference to the predefined set position while continuously moving the camera substrate at a fixed speed without stopping movement of the camera substrate, and then analyzing the plurality of pieces of imaging data; and
the assembly step includes assembling the camera substrate to the optical system after the position and angle of the camera substrate are readjusted so that the image sensor is in the assembly state identified in the in-focus state identification step.

3. The focus adjustment method according to claim 1, further comprising:
an in-focus state identification step of causing the image sensor to image a chart image disposed at a predefined position through the optical system and analyzing imaging data to identify an assembly state of the image sensor that in focus, wherein
the in-focus state identification step includes acquiring a plurality of pieces of imaging data by causing the image sensor to image the chart image within a predefined scanning range set with reference to the predefined set position while continuously moving the camera substrate without stopping movement of the camera substrate, and then analyzing the plurality of pieces of imaging data in parallel with acquisition of the imaging data; and
the assembly step includes assembling the camera substrate to the optical system after the position and angle of the camera substrate are readjusted so that the image sensor is in the assembly state identified in the in-focus state identification step.

4. The focus adjustment method according to claim 2, wherein
slit light generated by covering a light source with a sheet having a slit formed therein is used as the chart image, and
the in-focus state identification step includes shortening an exposure time to an extent that the chart image is able to be identified.

5. The focus adjustment method according to claim 3, wherein
slit light generated by covering a light source with a sheet having a slit formed therein is used as the chart image, and
the in-focus state identification step includes shortening an exposure time to an extent that the chart image is able to be identified.

6. The focus adjustment method according to claim 2, wherein
the scanning area in the in-focus state identification step is set by excluding an area without the chart image, of the imaging area of the image sensor, and
the scanning area is narrower than the imaging area that is imagable by the image sensor.

7. The focus adjustment method according to claim 3, wherein
the scanning area in the in-focus state identification step is set by excluding an area without the chart image, of the imaging area of the image sensor, and
the scanning area is narrower than the imaging area that is imagable by the image sensor.

8. A focus adjustment method for a camera module equipped with an optical system, an image sensor, and a camera substrate to which the image sensor is mounted, comprising:
an in-focus state identification step of causing the image sensor to image a chart image disposed at a predefined position through the optical system and analyzing imaging data to identify an assembly state of the image sensor that in focus;
an adjustment step of adjusting a position and an angle of the camera substrate relative to the optical system so that the image sensor is in the assembly state identified in the in-focus state identification step; and
an assembly step of assembling the camera substrate to the optical system, wherein
the in-focus state identification step includes acquiring a plurality of pieces of imaging data by causing the image sensor to image the chart image while continuously moving the camera substrate without stopping movement of the camera substrate, and then analyzing the plurality of pieces of imaging data.

9. A focus adjustment method for a camera module equipped with an optical system, an image sensor, and a camera substrate to which the image sensor is mounted, comprising:
an in-focus state identification step of causing the image sensor to image a chart image disposed at a predefined position through the optical system and analyzing imaging data to identify an assembly state of the image sensor that in focus;
an adjustment step of adjusting a position and an angle of the camera substrate relative to the optical system so that the image sensor is in the assembly state identified in the in-focus state identification step; and
an assembly step of assembling the camera substrate to the optical system, wherein
the in-focus state identification step includes acquiring a plurality of pieces of imaging data by causing the image sensor to image the chart image while continuously moving the camera substrate without stopping movement of the camera substrate, and then analyzing the plurality of pieces of imaging data in parallel with acquisition of the imaging data.
